(19) United States
(12) Patent Application Publication
(10) Pub. No.: US 2023/0342602 A1
(43) Pub. Date: Oct. 26, 2023

(54) ELECTRONIC DEVICE AND METHOD FOR CONTROLLING SAME

(71) Applicant: SAMSUNG ELECTRONICS CO., LTD., Suwon-si (KR)

(72) Inventors: Jijoong Moon, Suwon-si (KR); Parichay Kapoor, Suwon-si (KR); Jihoon Lee, Suwon-si (KR); Geunsik Lim, Suwon-si (KR); Myungjoo Ham, Suwon-si (KR)

(73) Assignee: SAMSUNG ELECTRONICS CO., LTD., Suwon-si (KR)

(21) Appl. No.: 18/216,824

(22) Filed: Jun. 30, 2023

Related U.S. Application Data
(63) Continuation of application No. PCT/KR21/15591, filed on Nov. 1, 2021.

(30) Foreign Application Priority Data
Dec. 30, 2020 (KR) 10-2020-0188126

(51) Int. Cl. G06N 3/08

(52) U.S. Cl. CPC G06N 3/08

(57) ABSTRACT

Disclosed are an electronic device including a memory and a processor, and a method for controlling same. The memory stores a pre-trained neural network model and training data. The processor obtains a first loss function based on a label corresponding to the training data and output data obtained by inputting the training data into the neural network model; obtains a size of a change amount of a weight of each of a plurality of layers included in the neural network model based on the first loss function, and trains the neural network model by updating a weight of at least one layer for which the magnitude of the change amount of the weight exceeds a first threshold value, while at least one other layer, among the plurality of layers, for which a size of the weight change amount does not exceed the first threshold value is not updated.

### CROSS-REFERENCE TO RELATED APPLICATIONS

This application is a bypass continuation application of International Patent Application No. PCT/KR2021/015591, filed on Nov. 1, 2021, which is based on and claims priority to Korean Patent Application No. 10-2020-0188126, filed on Dec. 30, 2020, in the Korean Intellectual Property Office, the disclosures of each of which are incorporated herein by reference in their entireties.

### BACKGROUND

### 1. Field

The disclosure relates to an electronic device and a method for controlling the same and, more particularly to, an electronic device configured to update a weight of at least one layer included in a neural network model and a method for controlling the same.

### 2. Description of Related Art

Recently, development and research on artificial intelligence systems implementing human level intelligence has been conducted. The artificial intelligence systems being developed perform learning and inference based on a neural network model, unlike an existing rule-based system, and are used in various fields and practices such as voice recognition, image recognition, and future prediction.

An artificial intelligence system to solve given problems using a deep neural network based on deep learning has been developed recently.

In systems in the related art, the deep neural network is generally trained using a huge amount of data and high computing power stored in a server, and a personal terminal receives and uses a pre-learned deep neural network from the server. Since the deep neural network has been trained in the server, there is a limit in that the deep neural network is not personalized according to the user characteristics of the personal terminal.

Accordingly, a method for personalizing a deep neural network according to user characteristics is devised. For example, a method for additionally training a deep neural network based on data related to a user has been devised by transmitting data related to the user to a server that has learned the deep neural network. However, there is a limitation that data related to a user may be transmitted to a server, thereby causing privacy invasion or security-related problems.

A method for training a deep neural network on a terminal in order to solve privacy invasion or security problems has been devised, but there is a limitation that it is difficult to additionally train a deep neural network in a terminal having limited resources.

### SUMMARY

To overcome the limitations of the related art as described above, provided are an electronic device that optimizes a weight included in at least one layer among a plurality of layers included in the neural network model, and a method for controlling the same.

An electronic device, according to an embodiment, may include a memory storing a pre-trained neural network model and learning data; and a processor configured to obtain a first loss function based on output data obtained by inputting the learning data to the neural network model and a label corresponding to the learning data, obtain a size of a weight change amount of each of a plurality of layers included in the neural network model based on the first loss function, and train the neural network model by updating a weight of at least one layer, among the plurality of layers, for which a size of the weight change amount exceeds a first threshold value, wherein at least one other layer, among the plurality of layers, for which a size of the weight change amount does not exceed the first threshold value is not updated.

A method of controlling an electronic device storing a pre-trained neural network model and learning data, according to another embodiment, may include obtaining a first loss function based on output data obtained by inputting the learning data to the neural network model and a label corresponding to the learning data; obtaining a size of a weight change amount of each of a plurality of layers included in the neural network model based on the first loss function; and training the neural network model by updating a weight of at least one layer, among the plurality of layers, for which a size of the weight change amount exceeds a first threshold value, wherein at least one other layer, among the plurality of layers, for which a size of the weight change amount does not exceed the first threshold value is not updated.

According to various embodiments as described above, a user may train a neural network model based on personal learning data on a terminal device having a limited memory and computing power.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram briefly illustrating a configuration of an electronic device according to an embodiment of the disclosure;

FIGS. 2, 3, and 4 are diagrams illustrating processes of training a neural network model by an electronic device, by selectively updating layers thereof, according to various embodiment of the disclosure;

FIG. 5 is a diagram illustrating a process of training a neural network model by an electronic device using a skip connection according to an embodiment of the disclosure;

FIG. 6 is a diagram illustrating a process of optimizing a weight of a layer included in a neural network model in a unit of a window by an electronic device according to an embodiment of the disclosure;

FIG. 7 is a diagram illustrating a process of training a neural network model by an electronic device according to an embodiment of the disclosure;

FIG. 8 is a flowchart diagram illustrating a method of controlling an electronic device according to an embodiment of the disclosure; and

FIG. 9 is a block diagram illustrating a configuration of an electronic device in detail according to an embodiment of the disclosure.

### DETAILED DESCRIPTION

The terms used in the disclosure and the claims are general terms identified in consideration of the functions of embodiments of the disclosure. However, these terms may vary depending on intention, legal or technical interpretation, emergence of new technologies, and the like of those skilled in the related art. In addition, in some cases, a term may be selected by the applicant, in which case the term will be described in detail in the corresponding description of the disclosure. Thus, the terms used in this disclosure should be interpreted based on the provided meaning of the terms, and the contents throughout this disclosure, rather than the simple name of the terms.

One or more specific embodiments of the disclosure are illustrated in the drawings and are described in detail in the detailed description. However, it is to be understood that the disclosure is not limited to the one or more specific embodiments, but includes all modifications, equivalents, and substitutions without departing from the scope and spirit of the disclosure. Also, well-known functions or constructions are not described in detail since they would obscure the disclosure with unnecessary detail.

In relation to explanation of the drawings, similar drawing reference numerals may be used for similar constituent elements.

As used herein, the terms “first,” “second,” or the like may identify corresponding components, regardless of importance of order, and are used to distinguish a component from another without limiting the components.

As used herein, a singular expression includes a plural expression, unless otherwise specified. Also, it is to be understood that the terms such as “comprise” and “include” may, for example, be used to designate a presence of a characteristic, number, step, operation, element, component, or a combination thereof, and not to preclude a presence or a possibility of adding one or more of other characteristics, numbers, steps, operations, elements, components or a combination thereof.

As used herein, expressions such as “A or B”, “at least one of A [and/or] B,”, or “one or more of A [and/or] B,” include all possible combinations of the listed items. For example, expressions such as “at least one of A [and/or] B,” or “one or more of A [and/or] B,” include all possible combinations of the listed items. For example, “at least one of A and B,” or “at least one of A or B” includes any of (1) at least one A, (2) at least one B, or (3) at least one A and at least one B.

As used herein, the expressions “have,” “may have,” “include,” or “may include” or the like represent presence of a corresponding feature (for example: components such as numbers, functions, operations, or parts) and does not exclude the presence of additional feature.

As used herein, the term “user” may refer either to a person using an electronic device or to a device using an electronic device (e.g., artificial intelligence electronic device).

Herein, if it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

As used herein, the expression “configured to” may be interchangeably used with other expressions such as “suitable for,” “having the capacity to,” “designed to,” “adapted to,” “made to,” and “capable of,” depending on cases. Additionally, the term “configured to” does not necessarily mean “specifically designed to” in terms of hardware. Instead, under some circumstances, the expression “a device configured to” may mean that the device “is capable of” performing an operation together with another device or component. As one example, the phrase “a processor configured to perform A, B, and C” may mean a dedicated processor (e.g., an embedded processor) for performing the corresponding operations, or a generic-purpose processor (e.g., a central processing unit (CPU) or an application processor) that can perform the corresponding operations by executing one or more software programs stored in a memory device.

As used herein, the terms “unit” or “module” include units consisting of hardware, software, or firmware, and are used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

Embodiments of the disclosure will be described in detail with reference to the accompanying drawings to aid in the understanding of those of ordinary skill in the art. However, the disclosure may be realized in various different forms and it should be noted that the disclosure is not limited to the various embodiments described herein. Further, in the drawings, parts not relevant to the description may be omitted, and like reference numerals may be used to indicate like elements.

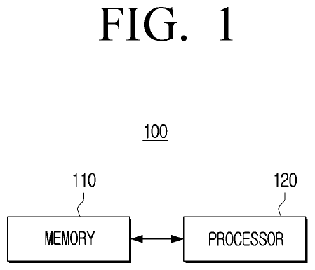

FIG. 1 is a block diagram schematically illustrating a configuration of the electronic device 100 according to an embodiment of the disclosure.

The electronic device 100 may be any device for training a neural network model (or an artificial intelligence model) or acquiring output data for input data by using a neural network model. For example, the electronic device 100 may be implemented as a desktop PC, a notebook, a smartphone, a tablet PC, a wearable device, or the like, but is not limited thereto.

As shown in FIG. 1, the electronic device 100 may include a memory 110 and a processor 120. However, the configuration illustrated in FIG. 1 is an example for implementing embodiments of the disclosure, and appropriate hardware and software configurations that are obvious to a person skilled in the art may be additionally included in the electronic device 100.

The memory 110 may store instructions or data related to at least one other elements of the electronic device 100. The memory 110 may be accessed by the processor 120, and may perform reading, recording, modifying, deleting, updating, or the like, of data by the processor 120.

As used herein, the term memory may be a read only memory (ROM), random access memory (RAM) in the processor 120, or a memory card (for example, micro secure digital (SD) card, a memory stick) mounted in the electronic device 100, among other suitable components for data storage. In the memory 110, programs, data, or the like, for configuring various screens to be displayed in a display area of the display may be stored.

The memory 110 may include a non-volatile memory capable of maintaining stored information even if power supply is stopped and a volatile memory requiring continuous power supply to maintain stored information. For example, a non-volatile memory may be implemented with at least one of one time programmable ROM (OTPROM), programmable ROM (PROM), erasable and programmable ROM (EPROM), electrically erasable and programmable ROM (EEPROM), mask ROM, flash ROM, and a volatile memory may be implemented with at least one of a dynamic random access memory (DRAM), a static random access memory (SRAM), or a synchronous dynamic random access memory (SDRAM).

The memory 110 may store a pre-trained neural network model. The pre-trained neural network model may be a model transmitted to the electronic device 100 after being trained in an external server. The neural network model includes a plurality of layers, and may include weight data trained by a server.

The memory 110 may store learning data capable of additionally training a pre-trained neural network model. The learning data may refer to data for personalizing a pre-trained neural network according to user characteristics. The configuration or type of learning data may be set or determined by a user.

The processor 120 may be electrically connected to the memory 110 for controlling overall operations and functions of the electronic device 100. The processor 120 may obtain a first loss function by using the output data obtained by inputting the learning data to the pre-trained neural network model and a label corresponding to the learning data. The label is an actual or “correct” value of output corresponding to the learning data being input to the neural network model—that is, the output that a perfectly accurate model would provide—and the loss function is a function that describes the difference between the output data and the label, in a manner that reflects a level or magnitude of error usefully for the context of the data and output.

The processor 120 may obtain a size of a weight change amount of each of a plurality of layers included in the neural network model based on the first loss function. The weight change amount of each of a plurality of layers means the number to be changed so that weights of each of the plurality of layers can minimize the first loss function value. The size of the weight change amount may be expressed as weight loss, size of return derivative, or size of differential (e.g., L2 norm of derivative).

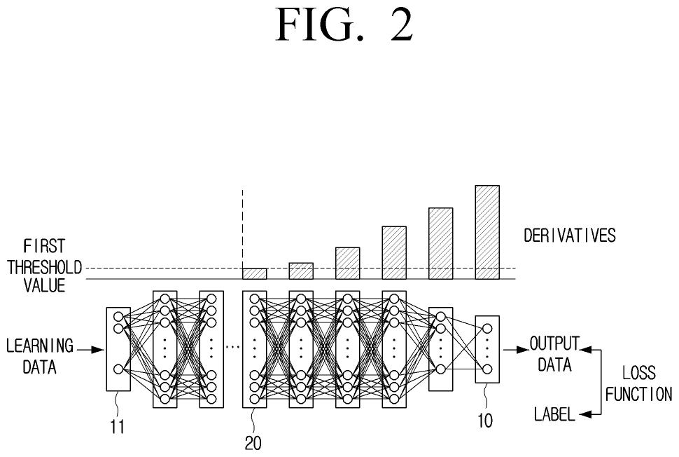

In an embodiment, the processor 120 may train a neural network model by updating a weight of at least one layer of which a size of a change amount of a weight exceeds a first threshold value among a plurality of layers. An embodiment related to the same will be described in detail with reference to FIGS. 2, 3, and 5.

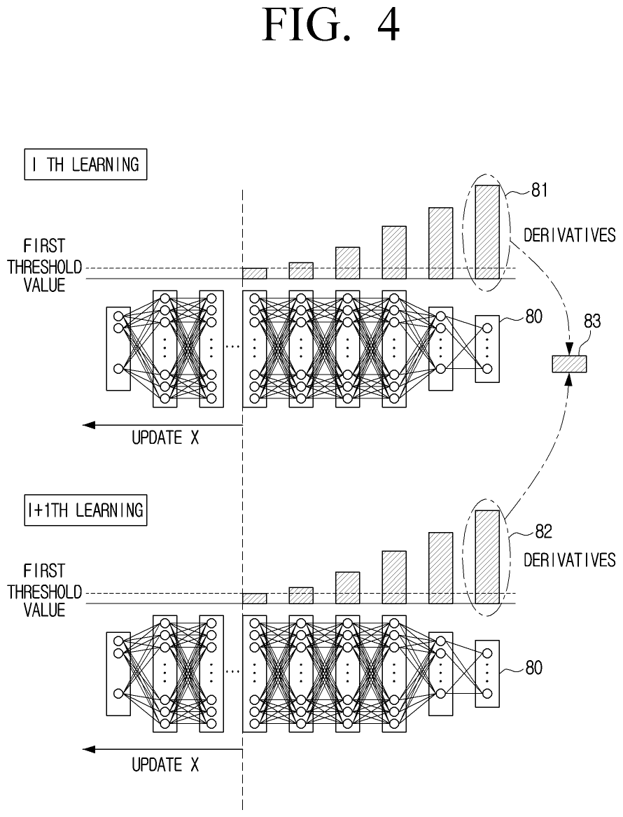

In another embodiment, the processor 120 may train a neural network model based on the difference between a weight change amount size of each of a plurality of layers and a weight change amount size of each of the plurality of layers based on i+1^{th} training being performed during training in a process of training a neural network model. An embodiment related to the same will be described in detail with reference to FIG. 4.

According to an embodiment, the processor 120 may insert a third layer into at least one of a plurality of layers included in a neural network model. That is, the processor 120 may insert the third layer into a neural network model, and the dimension of the third layer may be automatically adjusted to the front/rear layer.

The processor 120 may obtain a second loss function by using output data obtained by inputting training data to a neural network model into which a third layer is inserted and a label corresponding to the learning data. In addition, the processor 120 may train the neural network model by updating the weight of the third layer based on the second loss function. That is, the processor 120 may train the neural network model by updating only the weighted value of the inserted third layer among the plurality of layers of the neural network model.

According to an embodiment, the processor 120 may reduce the size of feature data (or activation data) extracted through learning data by a predetermined size. The processor 120 may reduce memory consumption by reducing the size of the feature data.

For example, it is assumed that learning data is image data, and the processor 120 may obtain feature data (for example, a feature map) of learning data by inputting learning data to an input layer of a neural network model. The processor 120 may reduce the size of the feature data by a predetermined size.

The processor 120 may insert a deconvolution layer or a depthwise layer into a neural network model. Dimension of feature data of reduced size may be returned by inserting a deconvolution layer or depthwise layer into a neural network model. The processor 120 may train a neural network model into which a deconvolution layer or a depthwise layer is inserted.

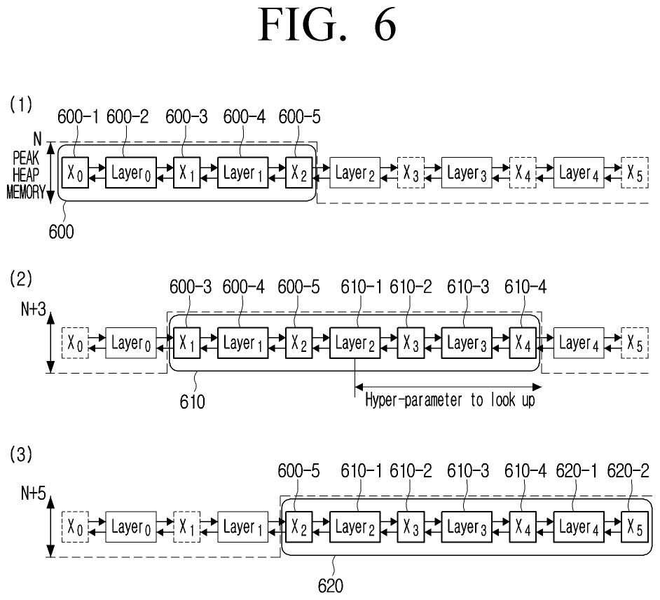

In another embodiment, the processor 120 may set at least one layer continuously connected among a plurality of layers and data, which may be input to at least one layer, as one window, and load only layers and data included in the window to perform an operation. After the operation is performed, the processor 120 may slide the window, load only layers and data included in the slid window, and unload other layers and data. An embodiment related to the same will be described in detail with reference to FIG. 6.

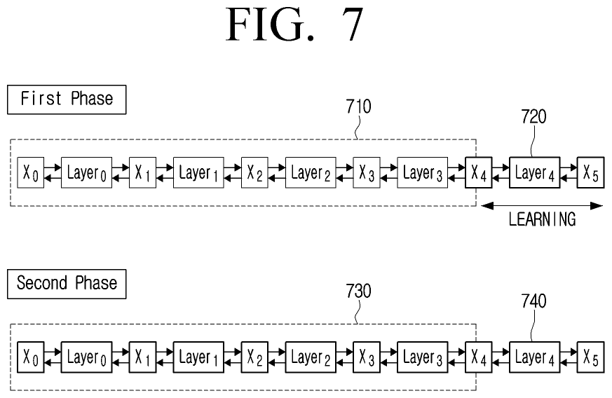

In another embodiment, the processor 120 may train an output layer by fixing a layer except an output layer among a plurality of layers and updating a weight of an output layer based on the learning data. In addition, the processor 120 may train a neural network model including the trained output layer. An embodiment related to the same will be described in detail with reference to FIG. 7.

The processor 120 may be composed of one or a plurality of processors. The one or a plurality of processors may be a general-purpose processor such as a central processor (CPU), an application processor (AP), a digital signal processor (DSP), a graphics-only processor such as a graphics processing unit (GPU), a vision processing unit (VPU), an AI-only processor such as a neural network processing unit (NPU), or the like.

A function related to artificial intelligence may operate through the one or a plurality of processors 120 and the memory 110. The one or a plurality of processors 120 may control processing of the input data according to a predefined operating rule or AI model stored in the memory 110. If the one or a plurality of processors are an AI-only processor, the AI-only processor may be designed with a hardware structure specialized for the processing of a particular AI model.

The predefined action rule or the artificial intelligence model is formed through training. The forming through training herein may, for example, imply that a predefined action rule or an artificial intelligence model set to perform a desired feature (or object) is formed by training a basic artificial intelligence model using a plurality of pieces of learning data by a learning algorithm. Such training may be performed in a device performing artificial intelligence functions according to the disclosure or performed by a separate server and/or system.

Examples of a learning algorithm include supervised learning, unsupervised learning, semi-supervised learning, or reinforcement learning, but the disclosure is not limited to the above examples unless otherwise specified.

An artificial intelligence model may include a plurality of neural network models and the neural network model may be composed of a plurality of layers. Each of the plurality of neural network layers have a plurality of weight values, respectively, and execute neural network operation through an operation result of a previous layer and operation between the plurality of weight values. The plurality of weight values of the plurality of neural network layers may be optimized by the training result of the artificial intelligence model. For example, the plurality of weight values may be updated to reduce or to minimize a weight loss value (e.g., size of weight change) or a cost value obtained by the artificial intelligence model during the training process.

The neural network model may include convolutional neural network (CNN), deep neural network (DNN), recurrent neural network (RNN), restricted Boltzmann machine (RBM), deep belief network (DBN), bidirectional recurrent deep neural network (BRDNN), deep Q-networks, or the like, but the disclosure is not limited to the above examples unless otherwise specified.

FIGS. 2, 3, and 4 are diagrams illustrating processes of training a neural network model by the electronic device 100, by selectively updating layers thereof, according to various embodiments of the disclosure.

The processor 120 may obtain output data by inputting learning data to an input layer of a neural network model. The processor 120 may obtain a first loss function by using output data and a label corresponding to the learning data. The processor 120 may obtain a weight change amount size of each of a plurality of layers included in a neural network model by using a first loss function.

For example, in order to minimize a value of a first loss function, the processor 120 may obtain a value (or a size of a weight change amount corresponding to an output layer) to which a weight of an output layer (or a last layer) 10 should be changed among a plurality of layers of a neural network model. That is, the processor 120 may obtain a value to which the weight should be changed in order to optimize the weight of the output layer by using the first loss function. The processor 120 may obtain a magnitude of a weight change amount of each of the plurality of layers based on the identified numerical value.

Rather than obtaining the size of a weight change amount of each layer the plurality of layers, the processor 120 may identify a weight change amount up to a layer in which the magnitude of the weight change amount is less than the first threshold value. For example, referring to FIG. 2, while the size of a weight change amount for each layer (labeled as “derivatives” in FIG. 2) is obtained from an output layer 10, working in a direction from the output layer 10 to an input layer 11, if it is identified that the size of a weight change amount of a layer after a specific layer 20 is less than a first threshold value, the processor 120 may stop a process of calculating the size of a weight change amount for each layer.

For example, working in a direction from the output layer 10 to the input layer 11, the processor 120 may identify an initial first layer (not depicted) in which the magnitude of a change amount of a weight is less than a first threshold with respect to the output layer 10 of a neural network model. In addition, the processor 120 may train a neural network model by updating one or more weights up to a layer 20 previous to the identified first layer, working in a direction from the output layer 10 to the input layer 11. That is, the processor 120 may personalize a neural network model even on a terminal including a limited resource by updating (or optimizing) only a weight of a layer in which a weight change amount is greater than or equal to a first threshold value, rather than training the entire neural network model.

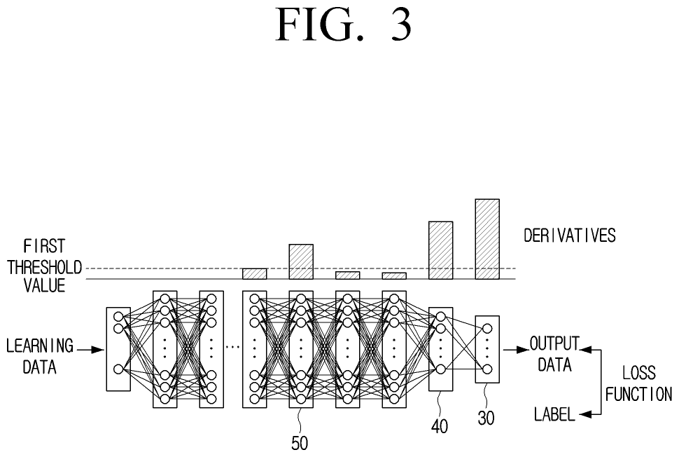

Alternatively, referring to FIG. 3, the processor 120 may identify layers 30, 40, 50 in which a weight change amount exceeds the first threshold value among a plurality of layers, and may update the weight of the identified layers 30, 40, 50 to train a neural network model. In such an embodiment, the process of calculating the size of a weight change amount for each layer may continue through all layers.

The first threshold value may be a preset value according to an experiment and study, and may be a value set by a user. As another example, based on the learning number of the neural network model—that is, the number of times the model has completed a learning process—exceeding a preset value, the processor 120 may update the first threshold value to a second threshold value, and the second threshold value may be a value smaller than the first threshold value. That is, the processor 120 may change the size of the first threshold value to a smaller value as the neural network model is trained further. Accordingly, the neural network model may be more precisely personalized based on learning data configured for personalization purposes.

Referring to FIG. 4, the processor 120 may store, in the memory 110, a weight change amount size of each of a plurality of layers acquired based on an i^{th} training of a neural network model being performed. In this case, the processor 120 may store a weight change amount size of each of the plurality of layers in the memory 110, but may store only a size of a weight change amount of a layer having a weight change amount equal to or greater than a first threshold value in the memory 110.

The processor 120 may acquire, for each layer, a difference between a weight change amount of each of a plurality of layers acquired in a process of training an i+1^{th} neural network model and a weight change amount size of each of the plurality of layers stored in the memory 110. In addition, the processor 120 may train a neural network model by updating a weight of a layer having a difference obtained from among a plurality of layers equal to or greater than a third threshold value.

For example, as shown in FIG. 4, the processor 120 may identify whether a difference 83 between a weight change amount 81 of an output layer 80 based on the neural network after i trainings and a weight change amount 82 of an output layer 80 based on the neural network after i+1 trainings is greater than or equal to a third threshold value. Based on the difference 83 being greater than or equal to a third threshold value, the processor 120 may train the neural network model by updating the weight of the output layer 80. The third threshold value may be a value preset by research or experiment, but is not limited thereto, and may be freely changed by a user.

The processor 120 may additionally omit training of a weight of a layer of which the weight change amount is less than the first threshold value.

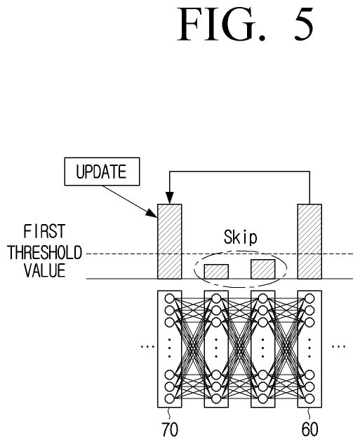

FIG. 5 is a diagram illustrating a process of training a neural network model by the electronic device 100 using a skip connection according to an embodiment of the disclosure. FIG. 5 assumes that the first layer 60 and the second layer 70 are connected by a skip connection structure.

The processor 120 may update only a weight of a layer having a weight change amount equal to or greater than a first threshold value among the plurality of layers. In this case, the processor 120 may transmit the weight change amount of the first layer 60 to the second layer 70 and update the weight of the second layer 70.

A weight update contribution of a layer present between the first layer 60 and the second layer 70 may be less than other layers. Therefore, the processor 120 may train a neural network model by skipping a layer having a low weight update contribution and updating the weights of the first layer 60 and the second layer 70. The processor 120 may reduce resources consumed by updating the weights of the layers other than layers having a low weight update contribution, rather than updating the weights of all layers included in the artificial neural network model.

FIG. 6 is a diagram illustrating a process of optimizing a weight of a layer included in a neural network model in a unit of a window by the electronic device 100 according to an embodiment of the disclosure.

The processor 120 may set at least one layer consecutively connected, among a plurality of layers and data related to the at least one layer as a single unit window.

For example, as shown in FIG. 6, in stage (1), the processor 120 may set a third layer (not shown), a fourth layer (layer₀) 600-2, and a fifth layer (layer₁) 600-4 which are consecutively connected as a single unit window 600. The number of layers to be included in one unit window 600 may be a preset number, but is not limited thereto, and the number of layers may be changed by a user. The window 600 also includes any data configured to be input to at least one layer in the window from either direction, namely, data (not shown) inputted to the third layer, data (X₀) 600-1 inputted to the fourth layer 600-2 and the third layer, data (X₁) 600-3 inputted to the fifth layer 600-4 and the fourth layer 600-2, and data (X₂) 600-5 inputted to the fifth layer 600-4.

The processor 120 may load layers and data included in a set window 600. Loading refers to an operation of allowing the processor 120 to access by loading a memory performing a storage function to a memory performing a function of a main memory among memories.

The processor 120 may perform a forwarding operation or a backwarding operation in relation to the layers and data included in the loaded window 600. The forwarding operation refers to an operation of performing an operation by using data and a weight from an output layer direction to an input layer direction. The backwarding operation refers to an operation of performing an operation by using data and a weight from an output layer direction to an input layer direction.

Based on the operation being completed in relation to the layers and data included in the window 600, the processor 120 may slide the window. Herein, “sliding the window” means moving the window by a preset unit in the direction of the output layer direction or the input layer direction, relative to the plurality of layers. The preset unit may be set or changed in size by a user.

For example, in stage (2), the processor 120 may slide the window 600 by a unit of two layers, along with data that may be input to each such layer. That is, the processor 120 may effectively replace window 600 with a slid window 610 to include the fifth layer (layer₁) 600-4, the sixth layer (layer₂) 610-1, and the seventh layer (layer₃) 610-3, and the data (X₁) 600-3, data (X₂) 600-5, data (X₃) 610-2, and data (X₄) 610-4 each configured to be input to at least one of the fifth layer 600-4, the sixth layer 610-1, and the seventh layer 610-3 by sliding the window.

The processor 120 may unload layers and data related solely to those layers no longer included in—that is, newly excluded from—the slid window 610 (e.g. fourth layer 600-2 and data 600-1), and may load newly included layers and data related thereto in the slid window 610 (e.g. sixth layer 610-1 and data 610-2). The processor 120 may perform a forwarding operation or a backwarding operation based on data set to be input to the layer and the layer included in the slid window 610.

In stage (3), after an operation is completed on the slid window 610, the processor 120 may slide the window again, and perform an operation based on a plurality of layers 610-1, 610-3, 620-1 and data 600-5, 610-2, 610-4, 620-2 included on the further slid window 620. In this additional sliding operation, the unit has been changed and the window is only slid by a unit of one layer; that is, the unit has been changed in size after the sliding of stage (2).

The processor 120 may load only a window including a subset of the plurality of layers and data to be input to each such layer rather than loading all of a plurality of layers included in the neural network model, and may perform an operation on the loaded window. After the operation is performed, the processor 120 may slide the window and load the layers and inputted data included in the slid window, thereby reducing memory consumption.

FIG. 7 is a diagram illustrating a process of training a neural network model by the electronic device 100 according to an embodiment of the disclosure.

In order to train an output layer among a plurality of layers included in the artificial neural network, a large amount of learning data may be desired. The electronic device 100 may be unable to store sufficient learning data related to a user, unlike a server. Therefore, the processor 120 may fix the layers other than the output layer and train the output layer by using the learning data. In addition, the processor 120 may further effectively train the neural network model by releasing the fixed layer and training all of the layers.

Referring to FIG. 7, as an embodiment, as a first phase, the processor 120 may fix a layer or set of layers 710, excluding the output layer 720, from among the plurality of layers, and may train the output layer by updating the weight of the output layer 720 based on the learning data. In this case, the output layer 720 may be a classifier.

As a second phase, after the output layer 720 is trained a preset number of times to become a trained output layer 740, the processor 120 may release the fixing of the fixed layer or fixed set of layers 710. That is, the neural network model now includes an unfixed layer or set of layers 730 and a trained output layer 740. The processor 120 may then train the neural network model by updating the weight included in the unfixed layer or set of layers 730 and the trained output layer 740 by using the learning data.

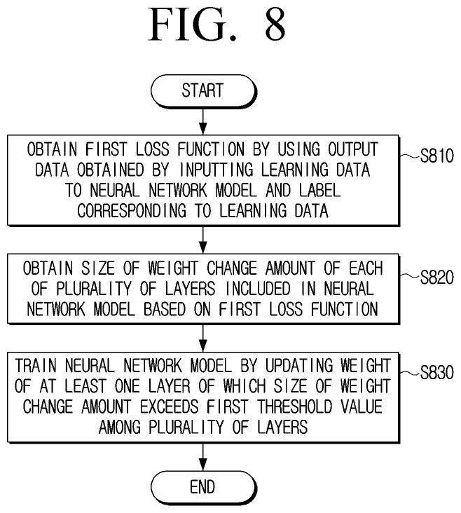

FIG. 8 is a flowchart diagram illustrating a method of controlling the electronic device according to an embodiment of the disclosure.

The electronic device 100 may obtain a first loss function by using output data obtained by inputting the learning data to the neural network model and a label corresponding to the learning data in operation S810. The neural network model refers to a model which has been pre-trained by a server and transmitted to the electronic device 100. The learning data input to the neural network model refers to data so that a neural network model may output a result value reflecting the user characteristics.

The electronic device 100 may obtain a size of a weight change amount of each of a plurality of layers included in the neural network model based on the first loss function in operation S820. The electronic device 100 may obtain the number to which the weight of the output layer should be changed to, that is, size of change amount of weight, to minimize the first loss function value. The electronic device 100 may obtain the weight change amount size of a next layer by using the obtained weight change amount size of the output layer and the first loss value, or the like.

The electronic device may obtain the size of the weight change amount of each layer of the plurality of layers, but is not limited thereto, and may instead obtain the weight change amount up to the layer whose size of weight change amount is less than a first threshold value.

The electronic device 100 may train the neural network model by updating a weight of at least one layer of which a size of the weight change amount exceeds a first threshold value among the plurality of layers in operation S830.

The electronic device 100 may identify an initial first layer in which the size of a weight change amount is less than the first threshold value based on the output layer of the neural network model, and train the neural network model by updating a weight from the output layer to a previous layer of the identified first layer among the plurality of layers.

As a still another example, the electronic device 100 may identify a layer of which a size of a change amount of a layer weight is greater than or equal to a first threshold value, and may update a weight of the identified layer to train a neural network model.

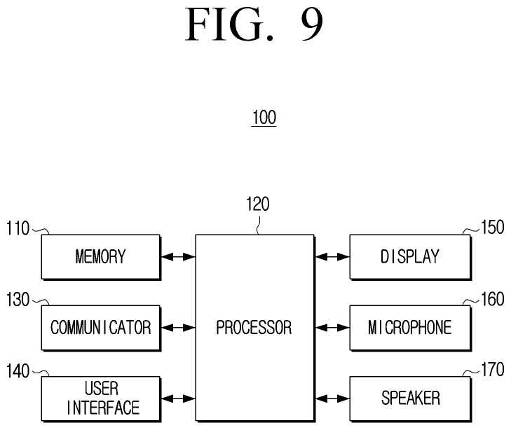

FIG. 9 is a block diagram illustrating a configuration of the electronic device 100 in detail according to an embodiment of the disclosure. As shown in FIG. 9, the electronic device 100 may include the memory 110, the processor 120, a communicator 130, a user interface 140, a display 150, a microphone 160, and a speaker 170. Since the memory 110 and the processor 120 have been described in detail with reference to FIGS. 1 to 7, repeated descriptions will be omitted.

The communicator 130 may include a circuitry and may communicate with an external device. The communication with an external device may include communicating via a third device (e.g., a relay, a hub, an access point, a server, a gateway, etc.).

The communicator 130 may include various communication modules for performing communication with an external device. For example, the communicator 130 may include a wireless communication module and may, for example, perform a cellular communication using at least one of 5th generation (5G), long-term evolution (LTE), LTE advanced (LTE-A), a code division multiple access (CDMA), or a wideband CDMA (WCDMA).

According to another embodiment, the wireless communication may use, for example, at least one of Wi-Fi, Bluetooth, Bluetooth low energy (BLE), Zigbee, radio frequency (RF), or body area network (BAN). Also, a wireless embodiment is merely an example and the communicator 130 may include a wired communication module.

The communicator 130 may receive a pre-trained neural network model from an external server. The communicator 130 may receive learning data from an external device. As another example, the communicator 130 may receive input data to be input to an additional trained neural network model based on the learning data from an external device.

The user interface 140 may include a circuit and may receive a user input for controlling the electronic device 100. The user interface 140 may include a touch panel for receiving a user touch using a user hand or a stylus pen, and a button for receiving user manipulation, or the like. In addition, the user interface 140 may be implemented as another input device (e.g., a keyboard, a mouse, a motion inputter). The user interface 140 may receive learning data input by a user or receive various user commands.

The display 150 may display various information under the control of the processor 120. In particular, the display 150 may display output data obtained by inputting input data to an additional trained neural network model based on learning data. Here, displaying the output data may include displaying a screen including a text or an image generated based on the output data.

The display 150 may be implemented with various display technologies such as a liquid crystal display (LCD), an organic light emitting diodes (OLED) display, an active matrix organic light emitting diode (AM-OLED) display, a liquid crystal on silicon (LCoS), or a digital light processing (DLP). In addition, the display 150 may be coupled to at least one of a front region, a side region, and a rear region of the electronic device 100 in the form of a flexible display.

The display 150 may be implemented with a touch screen including a touch sensor.

The microphone 160 is configured to receive a voice from a user. The microphone 160 may be provided inside the electronic device 100, but may be provided outside and electrically connected to the electronic device 100. In addition, based on the microphone 160 being provided outside, the microphone 160 may transmit, to the processor 120, a user voice signal generated through a wired/wireless interface (for example, Wi-Fi, Bluetooth).

The microphone 160 may receive a user voice including a wake-up word (or a trigger word) capable of activating an artificial intelligence model composed of various artificial neural networks. Based on a user voice including the wake-up word being received through the microphone 160, the artificial intelligence model may be activated.

The speaker 170 is configured to output various audio data, which may have been processed through decoding, amplification, and noise filtering.

The speaker 170 may also output various notification sounds or speech messages. For example, if a neural network model is trained in excess of predetermined numbers based on learning data, notification sounds that a neural network model is additionally trained may be output.

The various embodiments described above may be implemented as software including instructions stored in a machine-readable storage media which is readable by a machine (e.g., a computer). The device may include the electronic device (e.g., electronic device 100) according to the disclosed embodiments, as a device which calls the stored instructions from the storage media and which is operable according to the called instructions. Based on the instructions being executed by a processor, the processor may directory perform functions corresponding to the instructions using other components or the functions may be performed under a control of the processor. The instructions may include code generated or executed by a compiler or an interpreter. The machine-readable storage media may be provided in a form of a non-transitory storage media. Herein, the term “non-transitory” means that the storage media does not include a signal and is tangible, but does not distinguish whether data is stored semi-permanently or temporarily in the storage media. For example, “non-transitory storage media” may include a buffer for temporarily storing data.

According to an embodiment, the methods according to various embodiments described above may be provided as a part of a computer program product. The computer program product may be traded between a seller and a buyer. The computer program product may be distributed in a form of the machine-readable storage media (e.g., compact disc read only memory (CD-ROM) or distributed online through an application store (e.g., PlayStore™). In a case of the online distribution, at least a portion of the computer program product (e.g., downloadable app) may be at least temporarily stored or provisionally generated on the storage media such as a manufacturer's server, the application store's server, or a memory in a relay server.

Further, each of the components (e.g., modules or programs) according to the various embodiments described above may be composed of a single entity or a plurality of entities, and some subcomponents of the above-mentioned subcomponents may be omitted or the other subcomponents may be further included to the various embodiments. Generally, or additionally, some components (e.g., modules or programs) may be integrated into a single entity to perform the same or similar functions performed by each respective component prior to integration. Operations performed by a module, a program, or other component, according to various embodiments, may be sequential, parallel, or both, executed iteratively or heuristically, or at least some operations may be performed in a different order, omitted, or other operations may be added.

What is claimed is:

1. An electronic device comprising:
a memory storing a pre-trained neural network model and learning data; and
a processor configured to:
obtain a first loss function based on output data, obtained by inputting the learning data to the neural network model, and a label corresponding to the learning data,
obtain a size of a weight change amount of each of a plurality of layers included in the neural network model based on the first loss function, and
train the neural network model by updating a weight of at least one layer, among the plurality of layers, for which a size of the weight change amount exceeds a first threshold value, wherein at least one other layer, among the plurality of layers, for which a size of the weight change amount does not exceed the first threshold value is not updated.

2. The electronic device of claim 1, wherein the processor is further configured to:
in a direction from an output layer to an input layer of the neural network model, identify an initial first layer for which the size of the weight change amount is less than the first threshold value, and
train the neural network model by updating a weight of at least one layer previous to the identified first layer in the direction from the output layer to the input layer.

3. The electronic device of claim 1, wherein the processor is further configured to:
based on a learning number of the neural network model exceeding a preset value, update the first threshold value to a second threshold value,
wherein the second threshold value is a value smaller than the first threshold value.

4. The electronic device of claim 1, wherein the processor is further configured to:
store, in the memory, a size of weight change amount of each layer of the plurality of layers obtained based on the neural network model being trained i times,
obtain, for each layer of the plurality of layers, a difference between a size of weight change amount of the layer obtained in an i+1^{th} training of the neural network model and the stored size of weight change amount of the layer, and
train the neural network model by updating the weight of at least one layer for which the obtained difference is greater than or equal to a third threshold value.

5. The electronic device of claim 1, wherein the processor is further configured to:
based on connection between a first layer of which the size of the weight change amount exceeds the first threshold value and a second layer in a skip connection structure, transmit the size of the weight change amount of the first layer to the second layer and update the weight of the second layer.

6. The electronic device of claim 1, wherein the processor is further configured to:
insert a third layer into a region of at least one of the plurality of layers,
obtain a second loss function based on output data, obtained by inputting the learning data to a neural network model into which the third layer is inserted, and the label corresponding to the learning data, and
train the neural network model by updating a weight of the third layer based on the second loss function.

7. The electronic device of claim 1, wherein the processor is further configured to:
reduce a size of feature data extracted through the learning data by a predetermined size,
insert a deconvolution layer into the neural network model, and
train the neural network model in which the deconvolution layer is inserted.

8. The electronic device of claim 1, wherein the processor is further configured to:
set a window to include at least a fourth layer consecutively connected among the plurality of layers and data related to the fourth layer,
perform an operation by loading each layer and data included in the window, and
following completion of the operation:
slide the window by a preset unit relative to the plurality of layers, such that the fourth layer is newly excluded from the window and a fifth layer is newly included in the window,
unload the fourth layer and data related solely to the fourth layer, and
load the fifth layer and data related to the fifth layer.

9. The electronic device of claim 1, wherein the processor is further configured to:
fix a layer, other than an output layer, among the plurality of layers,
update a weight of the output layer based on the learning data, and
train the neural network model including the trained output layer.

10. A method of controlling an electronic device storing a pre-trained neural network model and learning data, the method comprising:
obtaining a first loss function based on output data, obtained by inputting the learning data to the neural network model, and a label corresponding to the learning data;
obtaining a size of a weight change amount of each of a plurality of layers included in the neural network model based on the first loss function; and
training the neural network model by updating a weight of at least one layer, among the plurality of layers, for which a size of the weight change amount exceeds a first threshold value, wherein at least one other layer, among the plurality of layers, for which a size of the weight change amount does not exceed the first threshold value is not updated.

11. The method of claim 10, wherein the training further comprises:
identifying an initial first layer, in a direction from an output layer to an input layer of the neural network model, for which the size of the weight change amount is less than the first threshold value based on the output layer of the neural network model, and
training the neural network model by updating a weight of at least one layer previous to the identified first layer in the direction from the output layer to the input layer.

12. The method of claim 10, further comprising:
based on a learning number of the neural network model exceeding a preset value, updating the first threshold value to a second threshold value,
wherein the second threshold value is a value smaller than the first threshold value.

13. The method of claim 10, further comprising:
storing a size of weight change amount of each layer of the plurality of layers obtained based on the neural network model being trained i times;
obtaining, for each layer of the plurality of layers, a difference between a size of weight change amount of the layer obtained in an i+1^{th} training of the neural network model and the stored size of weight change amount of the layer; and
training the neural network model by updating the weight of at least one layer for which the obtained difference is greater than or equal to a third threshold value.

14. The method of claim 10, further comprising:
based on connection between a first layer of which the size of the weight change amount exceeds the first threshold value and a second layer in a skip connection structure, transmitting the size of the weight change amount of the first layer to the second layer and updating the weight of the second layer.

15. The method of claim 10, further comprising:
inserting a third layer into a region of at least one of the plurality of layers;
obtaining a second loss function based on output data, obtained by inputting the learning data to a neural network model into which the third layer is inserted, and the label corresponding to the learning data; and
training the neural network model by updating a weight of the third layer based on the second loss function.
